(19) United States
(12) Patent Application Publication
(10) Pub. No.: US 2005/0268770 A1
(43) Pub. Date: Dec. 8, 2005

(54) Frets for stringed instruments and a method for manufacturing them

(76) Inventor: Hiromi Sakai, Fujisawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/862,333

(22) Filed: Jun. 8, 2004

(51) Int. Cl. G10D 1/08; G10D 3/06

(52) U.S. Cl. 84/314 R

(57) ABSTRACT

The invention is to provide frets for stringed instruments which can do away with a progress for scraping both ends of a fret main body after the frets for stringed instruments are installed into a fingerboard, and is such that both ends of the fret main body are formed in a shape along a cross-sectional shape of the fingerboard in both sides of the fingerboard in the frets for stringed instruments driven into fret grooves of a fingerboard each of which is provided with a fret main body for dividing a surface of the fingerboard and a leg portion standing unitedly on an underside of the fret main body.

### BACKGROUND OF THE INVENTION

This invention relates to frets for stringed instruments which are used in stringed instruments such as acoustic guitars etc. and a method for manufacturing them.

A plurality of frets each of which consists of a slender metal piece are provided in specific intervals in a direction which strings are stretched on a fingerboard in stringed instrument such as guitars etc., so that a halftone is changed every one fret by means of moving a position of a string supported by the fret.

The fret is a shape as shown in FIG. 9 of JP 2002-41029 A, it is shown in FIG. 10 of drawings in this application as a prior art. This fret 1 is provided with a fret main body 2 whose cross-sectional view is a slender arc shape and a leg portion 3 which is formed unitedly overall in middle of an underside of the fret main body 2. Both ends of the fret main body 2 are cut perpendicularly to a length direction thereof and both ends of the leg portion 3 are cut perpendicularly of the length direction at positions receding from the ends. The frets are delivered from companies manufacturing frets as they are.

The fret 1 is, as shown in FIG. 11, installed into a fret insertion groove 18 formed on the fingerboard 17 unitedly attached on an upper surface of a neck 16 by pressing. In thus case, both ends of the fret project from the fingerboard 17, so that it is not available to be used because of sticking a finger. Therefore, the projecting portions of the ends are scraped till the position shown in a dotted line along a cross-sectional shape of the fingerboard 17 by a buff.

Thus, a progress such as scraping the end portions projecting from the fingerboard has remained after the frets are installed on the fingerboard. The scraping progress was effective until when an error for attaching the frets into the fingerboard (an error in a width direction) was arisen, but it became useless since the frets were installed into the fret insertion grooves exactly currently.

### SUMMARY OF THE INVENTION

An object of the invention is to do away with a progress for scraping both ends of a fret main body of a fret used in stringed instruments to design to simplify progress.

Accordingly, this invention is frets for stringed instruments driven into fret grooves of a fingerboard each of which is provided with a fret main body for dividing a surface of the fingerboard and a leg portion standing unitedly on an underside of the fret main body, wherein both ends of the fret main body are formed in a shape along a cross-sectional shape of the fingerboard in both sides of the fingerboard.

Besides, it is preferred that the shape is constituted of an inclination at a specific angle formed in each end of the fret main body.

Thus, since the both ends of the fret main body are formed in the shape same as the cross-sectional shape of the fingerboard, namely in an inclinational shape beforehand, a fret becomes that what is necessary is just to attach in a fingerboard, and, as a result, the progress for scraping the both ends after the installation can be omitted.

Furthermore, the shape is preferably constituted of a standing-up portion standing from a lower part of each end of the fret main body and an inclination at a specific angle continuing from the standing-up portion.

Accordingly, an area which can be modified may be remained a little in both ends of the fret.

Besides, a method for manufacturing frets for stringed instruments according to the invention is preferably constituted of fixing a continuous fret line provided with a fret main body above thereof and a leg portion below thereof; cutting and separating a fret with a specific length from the continuous fret line by moving an end mill having an inclination scraping portion and a plan scraping portion from one side thereof perpendicularly to the continuous fret line, while forming the inclination in an end of the fret main body of the cut-off fret and an end of the continuous fret line and forming cutting-out portions spaced at a specific dimension in the end of the leg portion of the cut-off fret and the end of the leg portion of the continuous fret line, respectively.

Thus, only by moving one end mill perpendicularly, progress for forming the inclinations and the cutting out portions in the both ends of the fret main body can be carried out simultaneously to cut off the fret.

Moreover, a method for manufacturing frets for stringed instruments according to the invention, is preferably constituted of fixing a continuous fret line provided with a fret main body above thereof and a leg portion below thereof; punch out the leg portion by moving a punch perpendicularly to the continuous fret line from one side thereof to form a cutting out portion in the leg portion; and dropping down a punch from an above of the cutting-out portion and cutting off the fret line to form the fret while inclinations at a specific angle are formed on an end of the cut-off fret and an end of the fret line, respectively.

Accordingly, the cutting-out portion is formed at the leg portion by one punch, and then forming the inclination and cutting at the same time can be achieved by another punch.

### BRIEF DESCRIPTION OF THE DRAWINGS

FIG. 1 is a front view of a fret according to a first working mode of the invention;

FIG. 2 is a partial enlarged diagram of an end of the fret according to the first working mode of the invention;

FIG. 3 is an illustration showing a condition before a fret is cut-off from a fret line;

FIG. 4 is an illustration showing a first method for manufacturing frets from a side direction;

FIG. 5 is an illustration showing the first method for manufacturing frets from a front direction;

FIG. 6 is an illustration showing a second method for manufacturing frets from a side direction;

FIG. 7 is an illustration showing the second method for manufacturing frets from a front direction;

FIG. 8 is a front view of a fret according to a second working mode of the invention;

FIG. 9 is a partial enlarged diagram of an end of the fret according to the second working mode of the invention;

FIG. 10 is a front view of a prior fret; and

FIG. 11 is a illustration showing a condition that the prior fret is driven in a finger board.

### DETAIL EXPLANATION OF THE INVENTION

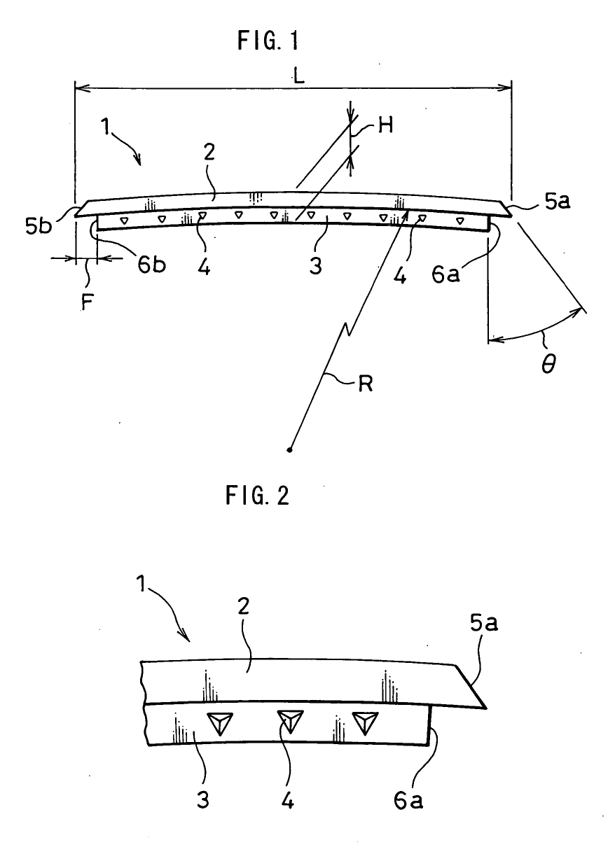

Hereinafter, working modes of the invention are explained according to the drawings. FIG. 1 is a front view of a fret 1 according to the invention and FIG. 2 is a partial enlarged diagram of an end of the fret 1. The fret 1 is provided with a fret main body 2 whose cross-sectional view is a slender arc shape and a leg portion 3 which is formed unitedly overall in middle of an underside of the fret main body 2, wherein a plurality of wedges 4 are formed along a length direction in the leg portion 3.

Both ends of the fret main body 2 of the fret 1 have inclination 5a, 5b respectively. An angle θ of the inclinations 5a, 5b is formed within approximately 20° to 60° regarding a line perpendicular to a length direction of the fret 1 as a reference line. Concretely, the angle θ is equal to a cross sectional shape of both side surfaces of the fingerboard on which the frets 1 are installed.

Cutting-out portions 6a, 6b are formed in both sides of the leg portion 3 of the fret 1 respectively. The cut-off portions 6a, 6b are cut off perpendicularly to the length direction of the fret 1 at positions backward from the both end thereof. Incidentally, length L of the fret 1 is approximately 30 mm-100 mm as same as a width dimension of the fingerboard of a stringed instrument, height H thereof is about approximately 2.50 mm-4.00 mm, the cut-off portion F is approximately 2.00 mm-3.00 mm and curvature radius R is approximately 180 mm-400 mm. Thus variety of condition such as length, etc., is arisen from differences by not only kinds of musical instruments but also positions of the frets.

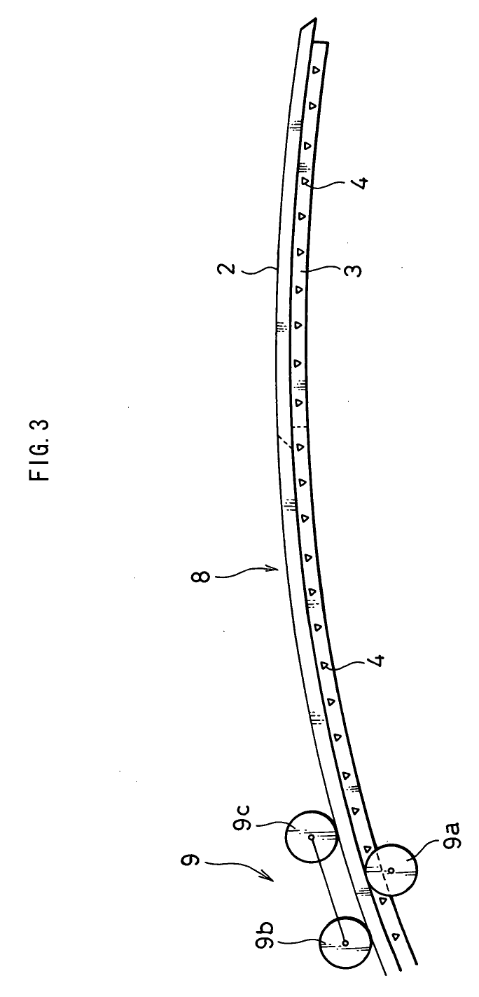

Hereinafter, a method for manufacturing frets 1 including the above structure is explained. As shown in FIG. 3, a long fret line 8 in which a fret main body 2 whose cross section is a half circle is formed on an upper side thereof and a leg portion 3 whose cross section is a square is formed on an underside thereof by processing steel specifically is transferred from a device not shown in the figures. The long fret line 8 is curved by a processing device 9 including three rollers 9a, 9b, 9c, before being cut it off at a specific length. Cutting position of the fret 1 is shown as a dotted line.

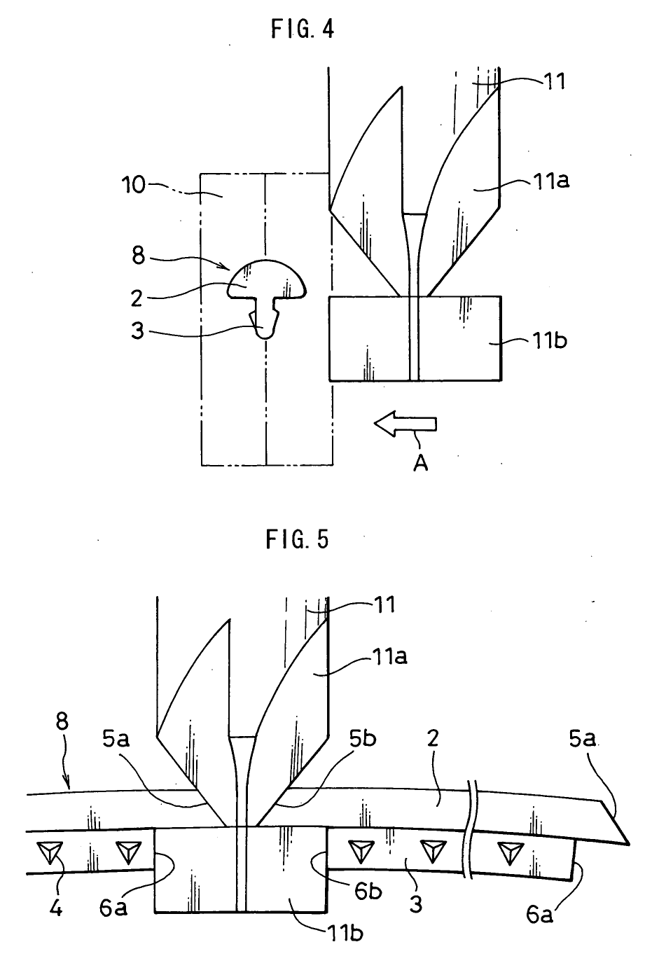

FIGS. 4 and 5 illustrate a first method for manufacturing. The fret line 8 transferred from any equipment not shown in figures is gripped by a gripper for fret line 10. Then, an end mill 11 having an inclination scraping unit 11a and a plan scraping unit 11b is moved in a direction as shown by an arrow A in FIG. 4 (a perpendicular direction). Then, the fret 1 is formed by cutting off an end portion of the fret line 8 at a specific length, while the inclination 5a at an end portion of the fret main body 2 of the fret line 8 and the inclination 5b at an end portion of the cut-off fret 1 are formed by the inclination scraping unit 11a at the same time, and the cutting-out portion 6a at an end of the leg portion 3 of the fret line 8 and the cutting-out portion 6b at an end of the cut-off fret 1 are formed by the plan scraping unit 11b at the same time.

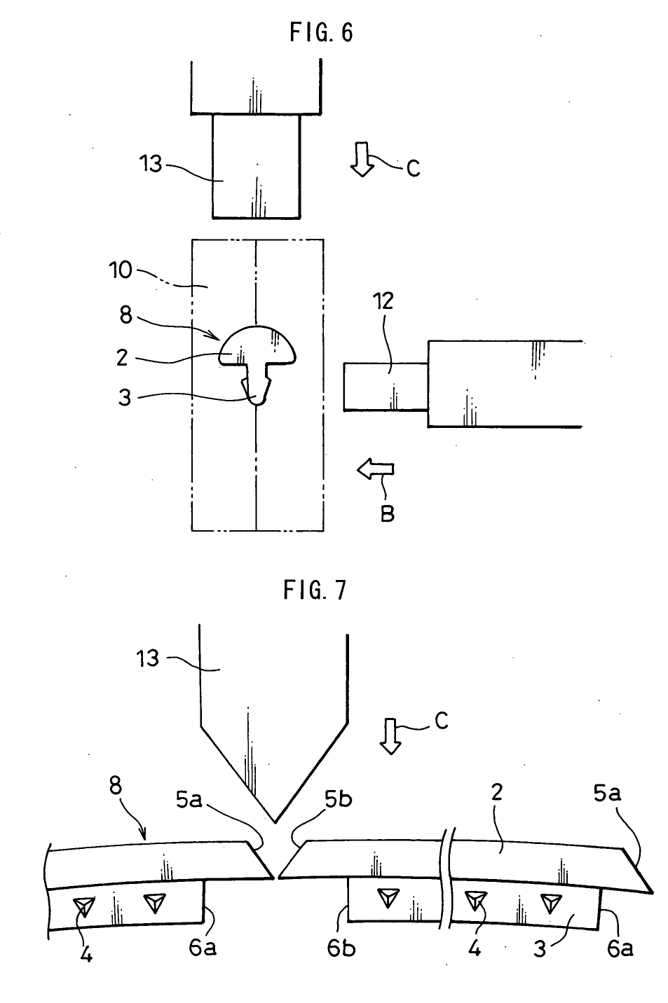

FIGS. 6 and 7 illustrate a second method for manufacturing. The fret line 8 transferred from any equipment not shown in figures is gripped by a gripper for fret line 10. Then, a punch 12 is moved to the leg portion 8 of the fret line 8 in a direction as shown by an arrow B (a perpendicular direction) to form cutting-out portions 6a, 6b at the leg portion 3 of the fret line 8. And then, a punch 13 is dropped down in a direction as shown by an arrow C to form the fret 1 by cutting off, while the inclination 5a at the end of the fret main body 2 of the fret line 8 and the inclination 5b at an end of the cut-off fret 1 are formed at the same time.

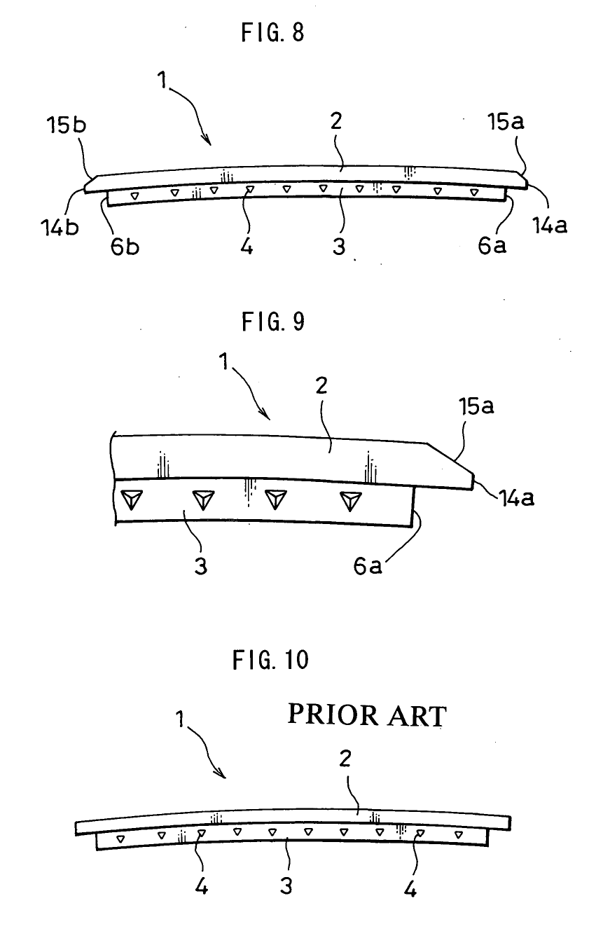

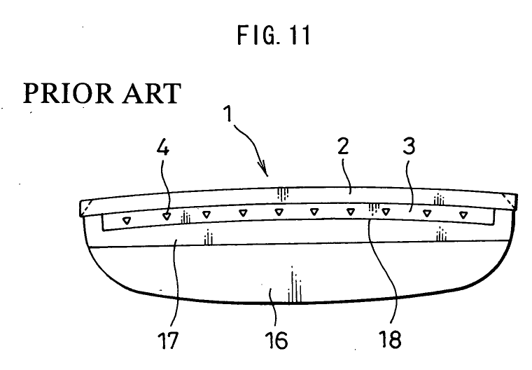

FIGS. 8 and 9 show another working mode of the invention. In a fret 1 according to this embodiment, it is different from the first working mode that shapes of both ends of the fret main body 21 of the fret 1 are constituted of standing-up portions 14a, 14b and inclinations 15a, 15b continuous from the standing-up portions 14a, 14b and are similar to cross sectional shapes of both side surfaces of the fingerboard, respectively. Accordingly, the frets can be modified by processing the ends thereof after the frets are installed into the fingerboard, so that an effect such as to prevent inferior goods can be gained.

As explained above, in the working mode illustrated in FIGS. 1 and 2, since each end of the fret main body has a shape such as to meet to a shape of the fingerboard, that is to say, inclination, there is an advantage such that a processing after driving the frets into the fingerboard can be omitted.

Besides, in the working mode illustrated in FIGS. 8 and 9, an effect such that spaces which can be modified are remained in the both ends of the fret main body is added.

The both methods for manufacturing frets are simple manufacturing processes. Namely, the frets can be manufactured by one tool and one movement in the first method for manufacturing, and the frets can be manufactured by two tools and simple movement in the second method for manufacturing.

1. Frets for stringed instruments driven into fret grooves of a fingerboard, each of which is provided with a fret main body for dividing a surface of said fingerboard and a leg portion standing unitedly on an underside of said fret main body;
wherein both ends of said fret main body are formed in a shape along a cross-sectional shape of said fingerboard in both sides of said fingerboard.

2. Frets for stringed instruments according to claim 1, wherein:
said shape is constituted of an inclination at a specific angle formed on said both ends of said fret main body.

3. Frets for stringed instruments according to claim 1, wherein:
said shape is constituted of a standing-up portion standing from a lower part of each end of the fret main body; and
an inclination with a specific angle continuing from the standing-up portion.

4. A method for manufacturing frets for stringed instruments according to claim 2, comprising:
fixing a continuous fret line provided with a fret main body above thereof and a leg portion below thereof; and
cutting and separating a fret with a specific length from said continuous fret line by moving an end mill having an inclination scraping portion and a plan scraping portion from one side thereof perpendicularly to said continuous fret line, while forming said inclination in an end of said fret main body of said cut-off fret and an end of said continuous fret line and forming cutting-out portions spaced at a specific dimension in said end of said leg portion of said cut-off fret and said end of said leg portion of said continuous fret line, respectively.

4. A method for manufacturing frets for stringed instruments according to claim 2, comprising:
fixing a continuous fret line provided with a fret main body above thereof and a leg portion below thereof;
punching out said leg portion by moving a punch perpendicularly to said continuous fret line from one side thereof to form a cutting out portion in said leg portion; and
dropping down a punch from an upper side of said cutting-out portion and cutting off said fret line to form said fret while inclinations at a specific angle are formed on an end of said cut-off fret and an end of the fret line respectively.
